(19) United States
(12) Patent Application Publication
(10) Pub. No.: US 2023/0065435 A1
(43) Pub. Date: Mar. 2, 2023

(54) DECENTRALIZED VOTING USING QUANTUM INTELLIGENCE

(71) Applicant: FORTIOR BLOCKCHAIN, LLLP, Sheridan, WY (US)

(72) Inventors: Brian Haney, Bellevue, WA (US); Archie Chaudhury, Peachtree City, GA (US)

(21) Appl. No.: 17/410,676

(22) Filed: Aug. 24, 2021

(51) Int. Cl. G07C 13/00; H04L 9/32; G06N 10/00; G06N 3/04

(52) U.S. Cl. CPC G07C 13/00; H04L 9/3239; G06N 10/00; G06N 3/04; H04L 2209/463

(57) ABSTRACT

The invention is a device and methods for decentralized voting. Embodiments of the invention are comprised of three steps. First, users in a decentralized network cast a vote. Second, the votes are aggregated and processed using cloud computing resources and validated using an artificial intelligence program. Third, a second artificial intelligence program iterates over the data, calculating the total votes and recording the results.

### BACKGROUND TO THE INVENTION

The field of the disclosure rests at the intersection of three broader fields, quantum computing, artificial intelligence, and blockchain. Blockchains are decentralized databases, maintained by distributed networks of computers. Artificial intelligence is a computer program replicating the thoughtful processes of the human mind. Quantum computing is a mechanistic process harnessing quantum mechanical processes. Converging these three fields, the invention relates to software for blockchain voting using quantum artificial intelligence.

Voting is an ancient tradition in human history. But not much has changed about the way in which humans vote more than 8,000 years since voting was first used in Athenian Democracy. In fact, just as the Greeks voted by show of hand, today humans vote with clicks—votes still depend on the system's integrity. The Decentralized Voting Problem concerns the process by which groups make decisions, specifically securing systems across information networks.

Voting is a method by which collective information is processed to determine consensus. A consensus is a defined majority or agreement. Voting happens across industry—in corporate shareholder meetings and political elections. In fact, voting is important because the right to vote is the central tenant of modern democracy, but also because it is a principle means for business practice. Its integrity critical to modern political societies and economic markets.

In the world of cryptocurrency transfers, the Decentralized Voting Problem requires formulating a way for participants to reach a consensus on how to distribute value without external interference or governance. For example, if an organization operating under a decentralized system needs a specific way to determine a governance change, the organization will use voting among certain members within the network to reach a decision. Defined, the decentralized voting problem is how to create a system where people can vote with weight associated value metrics? Another way, how can organizations conduct reliable and secure decentralized polls with value metrics? To answer these questions, the present invention borrows elements across the technical spectrum, appreciating a confluence of computational architecture.

The term artificial intelligence (AI) has been discussed at length by various scholars and industry leaders. Generally, AT refers to any machine capable of learning, remembering, and taking actions. AI technology is affecting industries across the economy including law, healthcare, and defense. AI automates tasks that were previously done manually, thus digitizing work and improving efficiency. For example, in the legal industry, technology assisted review is changing the discovery process. In other words, AI programs now complete tasks previously only lawyers could do, like classify documents based on relevancy during discovery according to evidentiary rules.

Broadly, AI is a field uniquely positioned at the intersection of several scientific disciplines including computer science, applied mathematics, and neuroscience. The AI design process is meticulous, deliberate, and time-consuming—involving intensive mathematical theory, data processing, and computer programming. All the while, AI's economic value is accelerating. One example of AI is deep learning, a process is inspired by the neurological structures found in the human brain. Both artificial and biological neurons receive input from various sources and map input information to a single output value. Artificial neurons model the strength of synapses, the connectivity between neurons, with weight coefficients. Thus, neural information transfer in the biological brain inspires the way in which modern neural networks operate. At the confluence of AI and blockchain technologies, great opportunity for innovation is available.

Another example of AI technology is reinforcement learning. Reinforcement learning algorithms contain three elements: (1) model: the description of the agent-environment relationship; (2) reward: the agent's goal; and (3) policy: the way in which the agent takes actions. For reinforcement learning systems, the environment represents the problem. Formally, reinforcement learning is often described through an agent-environment interaction, with the Markov Decision Process. The integration of reinforcement learning systems with deep learning technologies is an edge area in software innovation—where applications on quantum hardware push technical progress.

A quantum computer is a physical system utilizing quantum physics in the computational process. Quantum computers differ from classical computers because of the way in which they process information. Classical computers process information with bits, a binary representation. However, quantum computers process information with qubits, which represent information in a complex vector space.

There are several types of quantum computers. Two early hardware models are adiabatic quantum computers and gate model quantum computers. Adiabatic quantum computers use the natural flow of electrical energy to perform computation, where gate model quantum computers directly controlled the flow of electrons in the computational process. New models are also evolving, such as photonic circuit boards, which are quantum computers using photons for scalable performance. Still, adiabatic quantum computers are the most evolved for industrial application.

The intersection of quantum computing and artificial intelligence offers great promise. For example, one of the central problems bottlenecking machine learning research is classical computational power limits. Quantum computing provides a solution, offering more processing power for less electric cost. Quantum artificial intelligence is a research field at the intersection of quantum computing and AI technologies, driving the cutting edge in technological innovation. Quantum artificial intelligence has great opportunity to truly secure and scale on blockchains. Reflecting this technical convergence, quantum intelligence refers to quantum programs which are goal oriented or have the ability to take actions and learn. The present invention exploits quantum intelligence on blockchains.

As an architecture, a blockchain is a distributed ledger which records transactions between parties. In other words, blockchain technology is both an infrastructure for data storage and management. From a computational perspective, the programming language C++ was originally the most commonly used for blockchain software development. However, other languages are used in development, for example both Python and C support blockchain construction, with Python becoming far more frequently used. The structure for the blockchain may be considered to have four parts: the network, the public-private key system, the transactional process, and mining. However, mining is not always an element for blockchains, particularly in proof-of-stake blockchains, such as Algorand which do not use mining.

The blockchain network consists of several computers, called nodes, which are connected via the internet. Each node in the network maintains a transaction record called a ledger, which acts as a parasitic function of the internet. The internet has two fundamental layers, the Transmission Control Protocol (TCP), which manages packet assembly, and the Internet Protocol (IP) which passes packets from one computer to another. Blockchain networks like Bitcoin, Ethereum, and Algorand ultimately rely on TCP and IP to operate and can be viewed as application protocols, sitting on top of the transport layer.

The peer-to-peer network developed to solve the double spending problem, where the same digital coin is spent more than once. For example, the blockchain protocol uses timestamps and a proof-of-work to record a public history of transactions. The timestamp captures the time of transactions on the network, while the proof-of-work validates transactions. The idea is nodes consider the longest chain to be the correct one and will continue working to extend it. In other words, nodes validate the longest chain, which is the only chain that will continue to be extended. The means by which nodes transact is through a system of Public-Private Key Cryptography.

In short, PPKC enables encrypted messages to be sent without the need for a shared key. For example, one of the first PPKC systems was the Rivest-Shamir-Adleman (RSA) algorithm. The RSA algorithm creates a mathematically linked key pair by multiplying two prime numbers together. While, multiplying two prime numbers is computationally inexpensive, figuring out which prime numbers were multiplied to get a number is computationally complex, making it possible to broadcast a public key while reserving a secure private key.

Other security mechanisms on blockchains utilize the SHA-256 hash algorithm. The SHA-256 algorithm is the foundation of blockchain mining. The SHA-256 is a one-way hash function, which processes any message of an arbitrary size into a condensed representation called a message digest. Presently, most believe there is no efficient algorithm, which can invert SHA-256. As a result, the only way to solve the SHA-256 is brute force search, trying different inputs until a satisfactory solution is found. Thus, the product of meticulous math, the SHA-256 is used commonly across industry in cybersecurity.

SHA-256 uses a sequence of sixty-four constant 32-bit words, K₀^{{256}}, K₁^{{256}}, . . . , K ₆₃^{{256}}, representing the first thirty-two bits on the fractional parts of the cube roots of the first sixty-four prime numbers. The words are stored as hex digits, which are binary representations of a 4-bit string. In sum, SHA-256 uses six logical functions, where each function operates on 32-bit words, which are represented as x, y, and z. The SHA-256 is described in two stages, preprocessing and hash computation. However, in certain embodiments, the SHA-512 which is a post-quantum derivative of the SHA-256 and more secure, may be utilized in the present invention to secure user or voter information.

In a blockchain, the transactions are bundled into blocks. A block is a data structure, aggregating transactions for inclusion in a public ledger. Each block consists of a hash value from the previous block, which are transactions happening in the last ten minutes, and a random integer called a nonce. Each block is broadcast to the network, presenting a complex algorithmic problem for validation. Solving blocks typically requires an enormous amount of computation, but verifying the solution is relatively simple. As such, graphics processing units are the most popular hardware tool for blockchain technologies.

A transaction communicates to a network an authorized information movement has occurred. The essential elements are a network of parties, an asset moved among those parties, and a process defining the procedures and obligations associated with the movement. In other words, transactions are data structures encoding the value transfer between participants in a system. While costly financial institutions have policed such transactions in the past, blockchain supports a network of traders to perform this function itself. As such, one of the most interesting aspects of blockchain technology is that a central authority does not need to verify transactions.

Algorand is a proof-of-stake blockchain, which evolved to improve security and power efficiency across the blockchain networks by limiting miners to validating transactions proportional to an ownership share. One problem Algorand solves is the majority override, a cryptographic hack which results from a competitive advantage in mining where one actor can control a majority of the nodes with more computing power. To combat the majority override problem, Algorand developed a proof-of-stake chain, differing from classical blockchains, which use a proof-of-work to validate transactions. Algorand also provides a democratic consensus mechanism for voting among nodes in its network.

A smart contract is a computer program which automatically executes, transferring cryptocurrency. In other words, smart contracts are programs that are logically executed on a blockchain without a central oversight. Smart contract technology finds itself drawing on principles of law, finance, and technology to create new type of machine all together. Previously, contracts were only written in human language, rather than live and changing computational systems. Algorand Smart Contracts (ASCs) are programs for blockchain transactions on the Algorand network. Traditionally, ASCs are separated into two main categories, stateful and stateless.

Stateless smart contracts are primarily used for signature authorities but can also validate transactions. In other words, Stateless Smart Contracts are essentially escrow functions. An escrow is a contractual arrangement in which a third party receives and disburses money or property for transacting parties. Usually, contractual performance depends on conditions agreed to by the transacting parties. They validate transactions between two parties, replacing traditional escrow accounts. Stateless Smart Contracts on the Algorand Network also act as signature delegators, signing transactions, thus validating them on the main blockchain network.

Stateful smart contracts are the Algorand Network's backbone. The term stateful refers to the contract's ability to store information in a specific state on the network. For example, one type of stateful smart contract is an opt-in contract, allowing the user to elect to receive certain assets. The stateful opt-in contract stores data on the Network, associating the receiving account and the specified asset. Stateful smart contracts can be combined with all the other features to produce even more complex application types. Stateful smart contracts are used for data storage, both global or local, and functional processing on the Algorand blockchain. For example, a stateful smart contract may be used as a voting method, storing data globally based on the result of several votes.

Representing a technical convergence of Stateless and Stateful Smart Contracts, Algogeneous Smart Contracts include an innovative integration with artificial intelligence. Where previous ASCs must be stateful or stateless, Algogeneous contracts may be stateful, stateless, or both. Algogeneous Smart Contracts are a new type of simple smart contact, integrated with AI for contractual compliance.

The problem in current voting systems is that they lack scalability and security. As a result, voting is often tampered with for purposes of political elections. Therefore, there exists a need for a new type of scalable and secure voting protocol. The disclosed invention meets this need, solving the decentralized voting problem.

### SUMMARY OF THE INVENTION

In embodiments, the disclosure is a decentralized voting device and associated methodologies, which may incorporate the laws of quantum mechanics to create an optimized voting machine on blockchain networks. The methodologies described are dedicated toward blockchain development and focused on voting with associated rights in corporate governance and scalable security for political voting. In certain embodiments, the disclosure is methods for decentralized voting using two artificial intelligence computer programs, collaborating to effectively secure and satisfy the requirements for a legitimate voting process.

The problem the invention solves is the decentralized voting problem using a general and heterogeneous algorithm for decentralized decisions and in certain embodiments quantum voting. There are two main advantages of the disclosed invention. First, the quantum security protocol insulates the voting mechanism from post-quantum cyber-attack techniques. Second, the artificial intelligence computer program processing the votes for autonomous execution and results reporting in an open and secure way, allowing decentralized decisions with open audits and validation.

### BRIEF DESCRIPTION OF THE DRAWINGS

FIG. 1 describes embodiments of the present invention as an information flow model including a voting interface integrated with a quantum secure protocol and an artificial intelligence computer program.

FIG. 2 describes embodiments of the present invention as an information flow model including where a user purchases Choice Coin software to be used as a voting token.

FIG. 3 describes embodiments of the present invention as an information flow model by which votes move from various voters to a hardware processor via a cloud interface.

FIG. 4 describes embodiments of the present invention as information flow model where votes are transferred from votes to the blockchain via a cloud computing system.

### DETAILED DESCRIPTION OF THE INVENTION

In certain embodiments, a smart contract is a computer program which automatically executes, moving decentralized data and other digital assets which represent votes. Moreover, smart contracts allow for automation and legitimacy to be codified for secure voting. More particularly, smart contracts on the Algorand Network avoid the high fees and mining costs associated with smart contracts developed on other blockchains, allowing the vote to take place without substantial fees. Algorand Smart Contracts (ASCs) are computer programs with various functions on the Algorand Network. The cryptographic code behind ASCs includes several systems and methods encrypted within the Algorand network but may be supplemented with additional security.

In certain embodiments, Stateless Smart Contracts validate votes among a population or organization. In other words, Stateless Smart Contracts approve the votes, aggregating them in a singular location on the blockchain. On the Algorand network, Stateless Smart Contracts also act as signature delegators, validating smart contracts on the main blockchain network. This validation mechanism may be used to add legitimacy to voting process and prevent fraud, as well as suppression because the entire voting process may be open and secure.

In certain embodiments, Stateful Smart Contracts control the logic for blockchain voting. The term stateful refers to the contract's ability to store information in a specific state on the network. Stateful Smart Contracts are contracts that live on the chain and are used to store data, such as votes for particular voters. The stateful contract stores voting data on the Algorand network by associating the receiving account and the specified vote in blockchain storage.

In certain embodiments, Heterogeneous Smart Contracts integrate both stateless smart contract and stateful smart contract functionality into a singular smart contract, which may be deployable in a single script executable. Algogeneous Smart Contracts advance the Heterogeneous Smart Contract architecture by including artificial intelligence computer programs, capturing human knowledge or intuition in the computational process. Both Heterogeneous Smart Contracts and Algogeneous Smart Contracts may be deployed from a command line interface, using various computer software languages such as C++, Python, Teal, or Solidity. One advantage for using heterogeneous smart contracts in the voting process is the simplicity with which the software may deployed, adding scalability to the process for decentralized decisions.

In certain embodiments, various forms of AI may be integrated within a Heterogeneous Smart Contract, Stateful Smart Contract, or Stateless Smart Contract to process votes. Broadly, and as used herein, AI refers to any computer program replicating the thoughtful processes associated the human mind. Certain types of AI used in various embodiments of the present invention include machine learning, neural networks, embedded intelligence. Machine learning is a process by which programs improve over time and through experience. Neural networks are used for machine learning using matrix multiplication and derivate calculations to learn from data over time. Embedded intelligence is a type of AI that utilizes human knowledge captured in a formal software architecture for decision making.

In certain embodiments the disclosure utilizes the Fortior Voting Protocol, a simplified voting process designed toward perfecting efficiency. The Protocol may allow organizations to assign votes to participants and governments to assign votes to populations. Voting processes using Choice Coin, a governance token, and the Choice Coin protocol may be open or closed to the members of a particular organization. The decisions or proposals will each have dedicated addresses on the Algorand blockchain with constituent addresses compiling the votes. For example, Votes may be tabulated through stateless smart contracts that send one Choice, the Choice Coin unit, to an address for the decision. Throughout the streamlined process the administrator may stop counting at any time to tabulate the results. The results are computed through a stateful smart contract counting the number of votes.

In certain embodiments, the Fortior Voting Protocol emphasizes the allocation of proper weight given in decision-making processes. Specifically, an embedded intelligence computer program enters parameters into the stateless smart contract upon successful validation of the voter's identity using a secure key. In such embodiments, the specific parameter is the stake, which is both recorded in the database and entered by the voter for validation. The stateless smart contract then sends a certain number of assets to a decision address, which uses an Algogeneous smart contract to aggregate votes and record results. Choice Coin and the Fortior Voting Protocol will help advance democratic decision making in groups, organizations, and governments.

In certain embodiments, the disclosed methods include adiabatic quantum computers (AQCs), which are supercomputers harnessing quantum state evolution to perform computation using qubits. For computation, AQCs use the Adiabatic Theorem, which includes two essential elements, the Ising Model, and a traverse magnetic field. The Ising Model is a classic method for statistical mechanics. The Ising Model is defined according to Equation (1).

$${H}_{s} ( s ) = - \frac{1}{2} {\sum }_{i} Δ ( s ) {σ}_{i}^{x} + ε ( s ) ( - {\sum }_{i} {h}_{i} {σ}_{i}^{z} + {\sum }_{i < h} {J}_{ij} {σ}_{i}^{z} {σ}_{j}^{z} ) . \qquad ( 1 )$$

Here, Hₛ(s) is the system's energy measurement.

In certain embodiments of the invention, the Initial Hamiltonian is defined, according to Equation (2).

$$- \frac{1}{2} {\sum }_{i} Δ ( s ) {σ}_{i}^{x} , \qquad ( 2 )$$

which is the lowest energy state where all qubits are in a superposition of all states and the Final Hamiltonian is defined according to Equation (3).

ε(s)(−Σᵢhᵢσᵢ^{z}+Σ_{i<j}Jᵢⱼσᵢ^{z}σⱼ^{z}), (3)

which is the lowest energy state for the system. In essence, the Hamiltonian is the sum of the Initial Hamiltonian and the Final Hamiltonian.

In certain embodiments, the Ising Model, uses a Hamiltonian energy measurement function to explain a quantum system's total energy and generate a randomized quantum sample. The input for the Hamiltonian function is the system's state and the output is the system's energy measurement. In other words, the Hamiltonian returns an energy measurement for a particular state space measured by the quantum computer. AQCs second essential element is a traverse magnetic field, which is magnetically manipulated to perform computation. Each qubit begins in an uncertain superposition encoded in a physical field. Then a field is applied to the qubits in flux, causing them to satisfy a binary state. This allows the computer to leverage quantum state evolution in sampling to search for a random result through a secure protocol.

In certain embodiments, the quantum protocol is used for breaking ties. Often votes may result in a tie, where each of two options receive an equal proportion or number of votes. In such a case, we introduce a quantum oracle for deciding a tie breaker. The quantum oracle rests on principles of quantum uncertainty, embedded in formal logic via electromagnetism and superconducting metals. The quantum oracle calls a random sample from an adiabatic quantum computer, processing quantum information to return a Boolean result. In turn, the Boolean result corresponds to a selection which determines an outcome in the event a vote results in a tie.

In certain embodiments, the disclosure is methodologies for a new type of voting, which may incorporate the laws of quantum mechanics to create an optimized voting machine on blockchain networks. The methodologies described are dedicated toward blockchain development and focused on voting with associated rights in corporate governance and scalable security for political voting. In short, the solution to the Decentralized Voting Problem is a weighted and generalizable quantum voting algorithm.

In certain embodiments, the disclosure is software methodologies utilizing heterogeneous smart contracts for voting. The heterogeneous smart contract may be run on a quantum computer or integrated with quantum logic to allow for adjustable security or improvement.

H′=H{S₀; S₁} (4)

H′→ψ(ai)=V* (5)

Equation (4) describes a heterogeneous smart contract with stateful and stateless functionality. Equation (5) defines the optimal decentralized voting protocol using a quantum artificial intelligence security wrapper.

In certain embodiments, the disclosure is methodologies voting using decentralized decision software. Various input variables are defined according to Equation (6), which may be exclusive.

vᵢ=uᵢ(0⊕1) (6)

vᵢ=uᵢ(0⊗1) (7)

Various input variables are defined according to Equation (7), which may be associated the same voting process or as alternative voting process, which is inclusive.

In certain embodiments, the disclosure is methodologies is voting using a utility token or other decentralized asset. Utility variables, which contain functional syntax, are defined according to Equation (8).

uᵢ∈Uᵢ (8)

uᵢ∈Uⱼ (9)

Utility variables, which contain functional syntax, are defined according to Equation (9). The utility variables may differ depending on certain conditions, such as classical or quantum mathematics, or inclusive or exclusive voting. For example, in some instances voters may be able to vote for more than one option. Moreover, protocols using the variables may be quantum or classical in computational and mathematical design.

In certain embodiments, votes are aggregated according to a standard summation. A utility function is defined according to Equation (10).

$${U}_{i} = {\sum }_{i = 0} {v}_{i} \qquad ( 10 )$$

$${U}_{j} = {\sum }_{j = 0} {v}_{j} \qquad ( 11 )$$

A second utility function is defined according to Equation (11). The two functions may be used to sum votes for two different options, such as candidates in an election or choices for charitable donation. In other words, the utility function adds the votes for a particular purpose, such as selecting an option for action or a candidate in an election.

In certain embodiments, the invention is methodologies for voting according to an artificial intelligence algorithm. A maximum function is defined according to Equation (12) for a classical algorithm.

$${ai}_{c} = arg {max}_{{v}_{i ⊗ J}} {U}_{i ⊗ j} ( \sum {v}_{i} ⊗ \sum {v}_{j} ) \qquad ( 12 )$$

$${ai}_{q} = arg {max}_{{v}_{i ⊕ J}} {U}_{i ⊕ j} ( \sum {v}_{i} ⊕ \sum {v}_{j} ) \qquad ( 13 )$$

Additionally, a maximum function is defined according to Equation (13) for the quantum case. Embodiments of the present invention may use either equation or both to maximize the integrity, security, or process by which voting occurs.

In certain embodiments, the invention is methodologies for voting using artificial intelligence. The votes may be totaled using either summations, as in Equation (12) and Equation (13) or using products depending on the specific embodiment or application. A maximum function is defined according to Equation (14) for the classical case.

$${ai}_{{c}^{*}} = arg {max}_{{v}_{i ⊗ J}} {U}_{i ⊗ j} ( \prod {v}_{i} ⊗ \prod {v}_{j} ) \qquad ( 14 )$$

$${ai}_{{q}^{*}} = arg {max}_{{v}_{i ⊕ J}} {U}_{i ⊕ j} ( \prod {v}_{i} ⊕ \prod {v}_{j} ) \qquad ( 15 )$$

Additionally, a maximum function is defined according to Equation (15) for the quantum case. Embodiments of the present invention may use either equation or both to maximize the integrity, security, or process by which voting occurs.

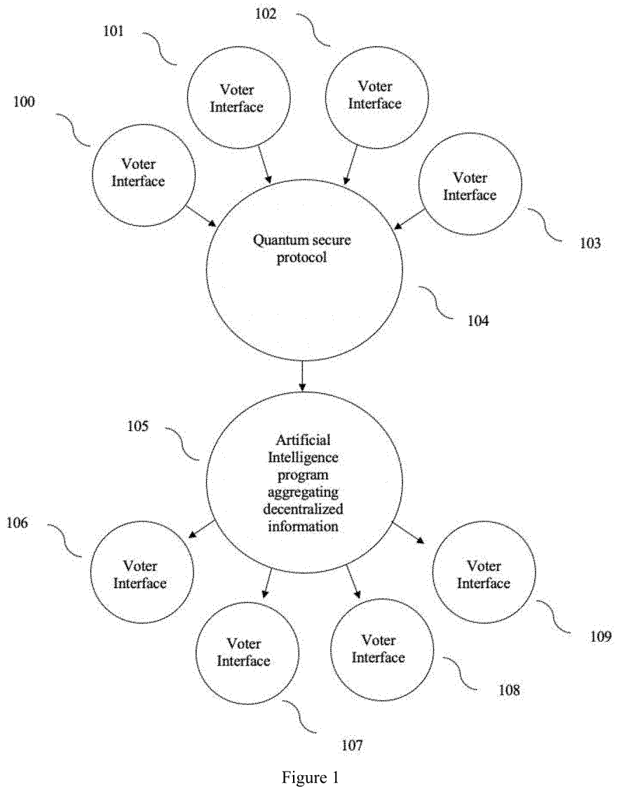

FIG. 1 describes embodiments of the present invention as an information flow model including a voter interface 100; a second voter interface 101; a third voter interface 102; and a fourth voter interface 103. The voters provide votes, which are received through a quantum secure voting protocol 104. Then, an artificial intelligence computer program aggregating vote data 105; and distributing the results to the first voter interface 106; the second voter interface 107; the third voter interface 108; and the fourth voter interface 109.

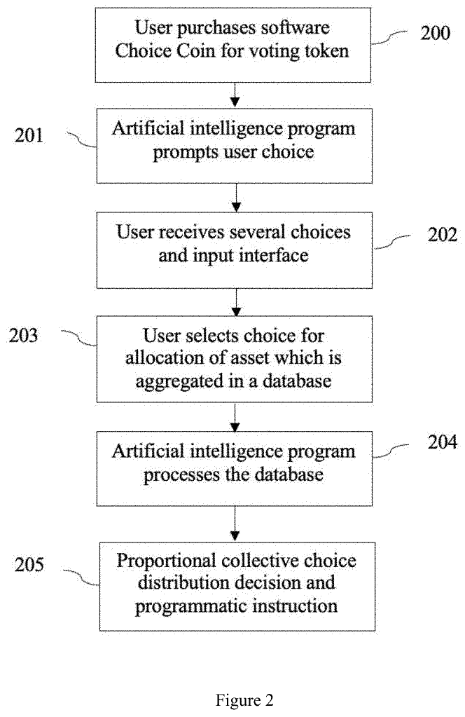

FIG. 2 describes embodiments of the present invention as an information flow model including where a user purchases software Choice Coin for voting token 200. An artificial intelligence program prompts user choice 201; user receives several choices and input interface 202. The user selects choice for allocation of asset which is aggregated in a database 203; and an artificial intelligence program processes the database 204. Finally, the artificial intelligence computer program produces a proportional collective choice distribution decision and programmatic instruction 205.

In certain embodiments, the main programming language used for decentralized decision development for decentralized decisions is Python. Python is general purpose and interpreted programming language. There are two main mechanisms by which Python code is written and deployed, PyTeal and the Algorand Python-SDK. PyTeal is a Python compiler for Algorand's Transaction Execution Approval Language (TEAL), a logical language for smart contracts. The Algorand Python-SDK is Python library for interacting with the Algorand network.

In certain embodiments, the front-end interface for the Decentralized Decisions software is developed using Flask. Flask allows developers to have independence with regards to the backend packages they may want to use within Python's ecosystem. Flask is designed for web-development and allows developers to render HTML files directly through a Python backend. Specifically, Flask is a Web Server Gateway Interface (WSGI) framework. As a result, Flask communicates effectively between the user and the Algorand blockchain with a Python backend.

In certain embodiments of the invention, the disclosed methods include Matrix transformations across both linear ⊕ and nonlinear ⊗ operators. The operations form the basis for a blockchain technology, the heterogeneous converter—which allows for a secure validation mechanism to communicate between a user interface for voting and the blockchain. Heterogeneous converters are intelligent programs between the internet and the blockchain. There are two types of converters, linear and nonlinear.

$$[ \begin{matrix}{x}_{l} \\ {x}_{m} \\ {x}_{n}\end{matrix} ] ⊗ [ \begin{matrix}{x}_{n} & {x}_{m} & {x}_{l}\end{matrix} ] ⊗ [ \begin{matrix}{x}_{n} \\ {x}_{m} \\ {x}_{l}\end{matrix} ] ⊗ [ \begin{matrix}{x}_{l} & {x}_{m} & {x}_{n}\end{matrix} ] ⊗ [ \begin{matrix}{x}_{l} \\ {x}_{m} \\ {x}_{n}\end{matrix} ] \qquad ( 16 )$$

$$[ \begin{matrix}{x}_{n} \\ {x}_{m} \\ {x}_{l}\end{matrix} ] ⊕ [ \begin{matrix}{x}_{l} & {x}_{m} & {x}_{n}\end{matrix} ] ⊕ [ \begin{matrix}{x}_{l} \\ {x}_{m} \\ {x}_{n}\end{matrix} ] ⊕ [ \begin{matrix}{x}_{n} & {x}_{m} & {x}_{l}\end{matrix} ] ⊕ [ \begin{matrix}{x}_{n} \\ {x}_{m} \\ {x}_{l}\end{matrix} ] \qquad ( 17 )$$

Equation (16) is a nonlinear blockchain converter. Equation (17) is a linear blockchain converter. Depending on the application heterogeneous converters of both types may be used to validate the integrity of the voting process.

In certain embodiments of the invention, the disclosed methods include information transfer methods which utilize one or more neural networks. The actor-critic neural networks may be used for several purposes among certain embodiments including adding security features and network validation processes.

$${x}_{l} \to {x}_{l + {1}_{\to }} \\ {x}_{m} \to {x}_{m + {1}_{\to }} {x}^{∘} \\ {x}_{n} \to {x}_{n + 1} \qquad ( 18 )$$

$${x}^{∘} \begin{matrix}{←}_{} {x}_{n + 1} ← {x}_{n} \\ {}_{←} {x}_{m + 1} ← {x}_{m} \\ {x}_{l + 1} ← {x}_{l}\end{matrix} \qquad ( 19 )$$

$${x}_{n} \to {x}_{n + {1}_{\to }} \\ {x}_{m} \to {x}_{m + {1}_{\to }} {x}^{∘} {x}^{*} {x}^{∘} \begin{matrix}{←}_{} {x}_{l + 1} ← {x}_{l} \\ {}_{←} {x}_{m + 1} ← {x}_{m} \\ {x}_{n + 1} ← {x}_{n}\end{matrix} \\ {x}_{l} \to {x}_{l + 1} \qquad ( 20 )$$

Equation (18) is an actor network for a neural network. Equation (19) is a critic neural network. Equation (20) is dualling or actor-critic neural networks. The dualling neural networks work to minimize error or potential vulnerabilities through matrix multiplication and backpropagation algorithms, which are trained on various datasets.

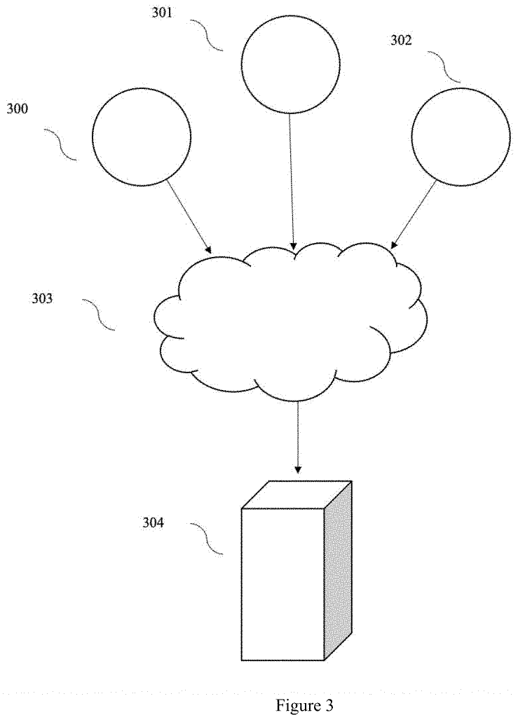

FIG. 3 describes embodiments as an information flow model by which a first voter 300, a second voter 301, and a third voter 302, vote. The voters send votes to the blockchain through an interface connected to cloud computing resources 303. The cloud interface and resources then transmit the votes to a hardware processor and database 304.

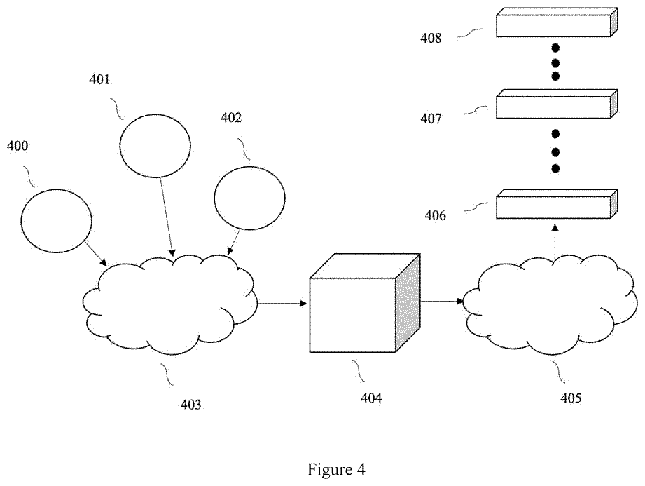

FIG. 4 describes embodiments of the present invention as information flow model by which a first voter 400, a second voter 401, and a third voter 402, vote. The voters provide data, sending votes through an interface connected to cloud computing resources 403. The autonomous platform transmits the votes to a hardware processor and database 404, moving the aggregated voting data via the cloud 405 to a first blockchain block 406. Then after time, the data migrates to a second blockchain block 407; and then after time, to a third blockchain block 408.

In certain embodiments, various public addresses will be used to compile the votes together. The votes themselves may be tabulated through Stateless Smart Contracts that send one Choice, or a Choice Coin derivative unit, to a smart contract. The process in such embodiments is efficient; where a semi-autonomous computer program stops at a defined time to tabulate the results. The results may be computed through a stateful smart contract on the Algorand blockchain that counts the number of votes, or the amount of Choice that each address has.

In certain embodiments, the Fortior Voting Protocol is utilized as a decentralized mechanism for voting on blockchains. The Fortior Voting Protocol enables organizations to decentralize their decision-making process, adding transparency and reducing barriers to entry. The protocol also allows data records to store on a decentralized blockchain for the purpose of both hosting data and pulling it to calculate and determine the winner. Choice Coin, a governance token for voting, powers the Fortior Voting Protocol, which will allow individuals to engage in decentralized voting for their organizations, or in other decentralized communities. The Protocol allows organizations to assign votes to participants and governments to assign votes to populations. Voting processes using Choice and the Fortior Voting Protocol may be open or closed to the members of a particular organization.

In certain embodiments, votes are recorded on the Algorand blockchain and are made available through the Algo Explorer, a user web interface for the Algorand blockchain. The Algo Explorer only records the public Algorand Address of the voter, ensuring that an individual voter's privacy and identity are kept private. In such embodiments, this may be done by hashing the required voter data into hexadecimal form through a SHA-512 protocol. SHA-512 is also a post-quantum cryptography protocol, ensuring that its collision-resistant property holds even when put up against a quantum computer. This ensures that private information is not leaked to malicious attackers. It is also an improvement over current systems, where voting records and other information are often made public without the consent of participants.

In certain embodiments, the disclosure is methods for decentralized voting using blockchain software. The methods may be performed using a computing device, which prompts a first artificial intelligence program, via an input interface including a plurality of selection options 201. The artificial intelligence computer program then allocates, by the computing device, a Choice Coin associated with the voter based on the vote by storing the Choice Coin in a database associated with one of the selection options 304. Then, the artificial intelligence computer program records, by the computing device using a second artificial intelligence program, the allocation as a smart contract in a blockchain structure 204. Then, the second artificial intelligence computer program generates a proportional collective choice distribution based on the Choice Coin being stored in the database in association with one of the selection options 405.

In certain embodiments, the disclosure is methods for decentralized voting using blockchain software. The methods may be performed using a computing device, which prompts a neural network, via an input interface including a plurality of selection options 100. The neural network then allocates, by the computing device, a Choice Coin associated with the voter based on the vote by storing the Choice Coin in a database associated with one of the selection options 404. Then, the neural network records, by the computing device using a reinforcement learning program, the allocation as a smart contract in a blockchain structure 204. Then, the reinforcement learning computer program generates a proportional collective choice distribution based on the Choice Coin being stored in the database in association with one of the selection options 406.

In certain embodiments, the disclosure is a computing device for blockchain vote processing. The computing device may include at least one processor and at least one memory device 404. The processor may be configured to store user input data via a user interface 400 and receive vote data using a first artificial intelligence computer program based on user input data stored in the database 104. A smart contract may transform data using a second artificial intelligence program to store the data as a smart contract in a blockchain structure 204.

It is to be understood that while certain embodiments and examples of the invention are illustrated herein, the invention is not limited to the specific embodiments or forms described and set forth herein. It will be apparent to those skilled in the art that various changes and substitutions may be made without departing from the scope or spirit of the invention and the invention is not considered to be limited to what is shown and described in the specification and the embodiments and examples that are set forth therein. Moreover, several details describing structures and processes that are well-known to those skilled in the art and often associated with blockchain technologies are not set forth in the following description to better focus on the various embodiments and novel features of the disclosure of the present invention. One skilled in the art would readily appreciate that such structures and processes are at least inherently in the invention and in the specific embodiments and examples set forth herein.

One skilled in the art will readily appreciate that the present invention is well adapted to carry out the objectives and obtain the ends and advantages mentioned herein as well as those that are inherent in the invention and in the specific embodiments and examples set forth herein. The embodiments, examples, methods, and compositions described or set forth herein are representative of certain preferred embodiments and are intended to be exemplary and not limitations on the scope of the invention. Those skilled in the art will understand that changes to the embodiments, examples, methods and uses set forth herein may be made that will still be encompassed within the scope and spirit of the invention. Indeed, various embodiments and modifications of the described compositions and methods herein which are obvious to those skilled in the art, are intended to be within the scope of the invention disclosed herein. Moreover, although the embodiments of the present invention are described in reference to use in connection with blockchain technology, ones of ordinary skill in the art will understand that the principles of the present inventions could be applied to other types of computers for a wide variety of applications.

We claim:

1. A computing device for blockchain vote processing, the computing device comprising at least one processor and at least one memory device, the processor configured to: store, in a database using computing resources, user input data which is input via a user interface; receive vote data using a first artificial intelligence computer program based on the user input data stored in the database; and transform smart contract data using a second artificial intelligence program to store the data in a smart contract in a blockchain structure.

2. The computing device of claim 1, wherein the first artificial intelligence computer program is a neural network, cleaning data and storing the data in the database.

3. The computing device of claim 1, wherein the first artificial intelligence computer program is an embedded intelligence, cleaning data and storing the data in the database.

4. The computing device of claim 1, wherein the blockchain structure is the Algorand Network.

5. The computing device of claim 1, wherein the blockchain structure is a proof-of-stake blockchain.

6. The computing device of claim 1, wherein the blockchain structure is a proof-of-work blockchain.

7. A method for voting, the method comprising a decentralized distribution mechanism using a blockchain technology software, receiving votes from voters, flowing through a quantum secure protocol, securing a network and moving the data to an artificial intelligence computer program, aggregating data from all voters, recording the results, and reporting the results to the voters through a voter interface.

8. The method of claim 7, wherein the artificial intelligence computer program is a neural network, aggregating data from all voters via cloud computing resources, providing access to a quantum computer.

9. The method of claim 7, wherein the artificial intelligence computer program is an embedded intelligence, aggregating data from all voters via cloud computing resources, providing access to a quantum computer.

10. The method of claim 7, wherein the quantum secure protocol uses an adiabatic quantum computer for processing the votes received from voters.

11. The method of claim 7, wherein the quantum secure protocol uses the SHA-512 algorithm to encrypt and secure voter information.

12. The method of claim 7, wherein the artificial intelligence computer program integrates a reinforcement learning computer program and a neural network computer program into one software, operating to aggregate data from all voters using cloud computing resources.

13. The method of claim 7, wherein the voter interface uses an Algogeneous smart contract, receiving and aggregating the votes according to an artificial intelligence computer program, securing the integrity of the voting process, using an optimized cybersecurity software.

14. The method of claim 7, wherein the voter interface uses a smart contract, receiving and aggregating the votes according to logical rules, resulting in the distribution of results, promulgating to the voters through the voter interface.

15. The method of claim 7, wherein the artificial intelligence computer program is an actor-critic neural network, and the quantum secure protocol uses a quantum computer to process votes.

16. A method for decentralized voting using blockchain software, the method performed using a computing device, the method comprising: prompting, by the computing device using a first artificial intelligence program, via an input interface including a plurality of selection options, a voter to vote; allocating, by the computing device, a Choice Coin associated with the voter based on the vote by storing the Choice Coin in a database in associated with one of the plurality of selection options; recording, by the computing device using a second artificial intelligence program, the allocation as a smart contract in a blockchain structure; and generating, by the computing device, a proportional collective choice distribution based at least in part on the Choice Coin being stored in the database in association with one of the plurality of selection options.

17. The method of claim 16, wherein the first artificial intelligence program is a deep reinforcement learning software including one neural network and one reinforcement learning algorithm.

18. The method of claim 16, wherein the first artificial intelligence program is a deep reinforcement learning software including two neural networks and one reinforcement learning algorithm.

19. The method of claim 16, wherein the second artificial intelligence program includes computer code defining formalized process with rules for processing data stored in the database.

20. The method of claim 16, wherein the second artificial intelligence program uses a deep reinforcement learning algorithm.
